(19) United States
(12) Patent Application Publication
(10) Pub. No.: US 2026/0307799 A1
(43) Pub. Date: Oct. 8, 2026

(54) AIRCRAFT COMPARTMENT PARTITION

(71) Applicant: ZIM IP AMERICA INC, Dover, DE (US)

(72) Inventors: Jose PEVIDA, Jamestown, NC (US); Robert PAPKE, Summerfield, NC (US)

(21) Appl. No.: 19/398,630

(22) Filed: Nov. 24, 2025

Related U.S. Application Data
(60) Provisional application No. 63/783,498, filed on Apr. 4, 2025.

(51) Int. Cl. B64D 11/06; B64D 11/00

(52) U.S. Cl. CPC B64D 11/0606; B64D 11/0015; B64D 11/003; B64D 11/0605; B64D 11/0643

(57) ABSTRACT

An aircraft compartment partition includes an aircraft partition wall and a footrest arranged on the aircraft partition wall so that, in the arranged state of the aircraft compartment partition in the aircraft, the footrest of the aircraft partition wall forms a rest surface for a foot of an aircraft passenger sitting on an aircraft seat adjacent to the aircraft partition wall.

### CROSS-REFERENCE TO RELATED APPLICATION

The present application is based on and claims the benefit of U.S. provisional patent application Ser. No. 63/783,498, filed Apr. 4, 2025, the contents of which are hereby incorporated by reference in their entirety.

### BRIEF DESCRIPTION OF THE DRAWINGS

FIG. 1 shows an aircraft seat ensemble comprising an aircraft seat row having two aircraft seats and an aircraft compartment partition in a side view, in one example.

FIG. 2 shows the aircraft seat ensemble according to FIG. 1 in a side view, wherein a footrest of the aircraft compartment partition is in a use state.

FIG. 3 shows a front view of the aircraft compartment partition according to FIG. 1.

FIG. 4 shows a plan view from above of the aircraft seat ensemble in the configuration according to FIG. 2.

FIG. 5 shows a further aircraft seat ensemble comprising an aircraft seat row having two aircraft seats and an aircraft compartment partition in a side view, wherein a footrest of an aircraft partition wall of the aircraft compartment partition is in a use state, in one example.

FIG. 6 shows the aircraft seat ensemble according to FIG. 5 with an additionally illustrated passenger.

FIG. 7 shows the aircraft seat ensemble according to FIG. 5, wherein the footrest is folded up into a stowage state.

FIG. 8 shows a further design of an aircraft compartment partition in a perspective illustration as seen obliquely from the side and from the front, wherein a footrest of the aircraft partition wall is in a use state, in one example.

FIG. 9 shows the aircraft compartment partition according to FIG. 8 in a front view.

FIG. 10 shows the aircraft compartment partition according to FIG. 8 in a rear view.

FIG. 11 shows the aircraft compartment partition according to FIG. 8 in a view from below.

FIG. 12 shows the aircraft compartment partition according to FIG. 8 in a side view.

FIG. 13 shows the aircraft compartment partition according to FIG. 8 in a perspective illustration as seen obliquely from the side and from behind.

FIG. 14 shows a perspective view, as seen obliquely from the side and from the front, of the footrest of the aircraft compartment partition according to FIG. 8, wherein the footrest is in a stowage state.

FIG. 15 shows a perspective view, as seen obliquely from the side and from behind, of the footrest according to FIG. 14.

FIG. 16 shows a perspective view, as seen obliquely from the side and from above, of the footrest according to FIG. 15 in a use state.

FIG. 17 shows a partial view of the footrest according to FIG. 16 as seen obliquely from the side, wherein parts of the footrest are shown transparently.

FIG. 18 shows a perspective view, as seen obliquely from the side and from below, of the footrest according to FIG. 16.

FIG. 19 shows a partial view of the footrest according to FIG. 18 as seen obliquely from the side and from below.

FIG. 20 shows a side view of the footrest according to FIG. 16.

### DETAILED DESCRIPTION

Passenger seats for mounting in an aircraft are known. For instance, passenger seats which have a passenger seat frame and a passenger seat backrest are known. Depending on the installation situation in an aircraft, the passenger seat backrest is movable, for example pivotable, relative to the passenger seat frame, or is fixed relative to the passenger seat frame. In addition, it is known that the passenger seat can have a footrest or legrest which is arranged, for example, pivotably on the seat frame so that the footrest or legrest is movable from a folded-down stowage state to an unfolded use state and back.

The aim of improvements to existing passenger seats is usually to reduce the weight of the passenger seat or to optimize the passenger seat in such a way that more living space is available to a user or that a user has improved operation of the passenger seat or the components arranged thereon, for example multimedia components.

The space to be made available to the users of a passenger seat is mainly limited downward by the body geometry of the user and the necessary movement space for a required evacuation time.

It is known that the passenger seats are arranged next to one another in the aircraft in a seat row of two, three, four or even five passenger seats. The passenger seats of a row are in turn spaced apart from passenger seats of a further, for example adjacent row in front or behind or else from aircraft compartment partitions. A space for a passenger or user of the passenger seat is specified by the distance of a passenger seat from the passenger seats or the aircraft compartment partition which in particular directly surround the passenger seat. The space is also referred to as living space.

An object of the present disclosure is to provide an improved aircraft compartment partition for an aircraft interior. In particular, to provide an improved aircraft compartment partition by means of which the so-called living space of an aircraft passenger is improved or increased or to provide an improved aircraft compartment partition by means of which a number of passenger seats in an aircraft can be comparatively increased.

This object is achieved by one or more of the features described herein.

The present disclosure is based on an aircraft compartment partition comprising an aircraft partition wall and a footrest arranged on the aircraft partition wall so that, in the arranged state of the aircraft compartment partition in the aircraft, the footrest of the aircraft partition wall forms a rest surface for a foot and/or a leg of an aircraft passenger sitting on an aircraft seat adjacent to the aircraft partition wall. As a result, comfort for a user of the aircraft seat or a passenger of an aircraft in which the aircraft partition wall is arranged is advantageously increased.

The aircraft compartment partition is designed, for example, as an aircraft interior wall. It is conceivable that the aircraft compartment partition is designed as an aircraft interior partition or as an element of aircraft interior equipment. For example, the aircraft compartment partition is provided, in the arranged state in the aircraft, for dividing or separating an aircraft interior into two space regions, for example into a space region for economy class passengers and into a space region for business class passengers. For example, the aircraft compartment partition is designed to divide an aircraft into two regions as seen in the longitudinal direction, for example in the flight direction.

For example, the aircraft partition wall extends in a length, a width and a height. It is conceivable that the aircraft partition wall has two outer sides which are opposite one another and are spaced apart by a width of the aircraft partition wall. Furthermore, it is conceivable that the aircraft partition wall has four narrow sides which extend along the length and the width or along the height and the width of the aircraft partition wall. It is also proposed that the aircraft partition wall is designed in such a way that, in the arranged state of the aircraft partition wall in the aircraft, the outer sides of the aircraft partition wall extend transversely to a flight direction of the aircraft and/or transversely to a seat direction of the aircraft seats surrounding the aircraft partition wall. It is conceivable that the aircraft partition wall is designed or constructed in a sandwich construction. For example, a narrow side of the aircraft partition wall is adapted to an inner contour of an aircraft cabin of an aircraft so that the narrow side can be arranged to bear flush against the inner contour. For example, the aircraft partition wall has support feet and/or mounting means to support the aircraft partition wall on the aircraft floor and/or to anchor it to the aircraft in the region of the aircraft floor.

It is conceivable that there are two, three, four or more footrests on the aircraft partition wall of the aircraft compartment partition. In particular, exactly one, exactly two or exactly three footrests are arranged on the aircraft partition wall. It is also conceivable that storage compartments and/or multimedia components, such as a monitor, are arranged on the aircraft partition wall.

For example, the footrest has a rest surface on which or with which a foot of a user can be laid or supported. For example, the rest surface is designed as a cushion. As a result, comfort for a user is comparatively increased. For example, the rest surface of the footrest is oriented horizontally in the use state of the footrest.

For example, the aircraft seat is designed as a passenger seat, for example as an aircraft passenger seat. It is conceivable that the aircraft seat has a seat frame and an aircraft seat backrest arranged on the seat frame. It is conceivable that the aircraft seat backrest is pivotable with respect to the seat frame.

It is also proposed that the aircraft partition wall has an opening through which, in the arranged state of the aircraft compartment partition in the aircraft, there can engage a foot of an aircraft passenger sitting on an aircraft seat adjacent to the aircraft partition wall. As a result, an available space in the aircraft is advantageously utilized. For example, it is thereby possible to use a clearance below a seat frame of an aircraft seat which is positioned on the opposite side of the aircraft partition wall in the aircraft.

It is conceivable that the aircraft partition wall has two, three, four or more spaced-apart openings. For example, in the arranged state in the aircraft, the openings are designed to be spaced apart from one another on the partition wall in a direction transverse to the flight direction of the aircraft. For example, the opening is designed as a through-opening. For example, the opening extends over the complete width of the aircraft partition wall. For example, the opening in the aircraft partition wall is present or formed as a footrest.

Furthermore, it is proposed that a movement mechanism is arranged on the aircraft partition wall so that, by means of the movement mechanism, the footrest is movable from a stowed position to a use position and back. This means that an additional space is advantageously provided in the event of evacuation.

It is conceivable that the footrest is arranged movably on the aircraft partition wall by means of the movement mechanism. For example, the footrest is movable or pivotable, for example rotatable, from a stowed state to a use state by means of the movement mechanism.

For example, the rest surface of the footrest is oriented horizontally or obliquely to the horizontal in the use state. For example, the rest surface of the footrest is oriented vertically in the stowage state. For example, the rest surface of the footrest in the stowage state is oriented parallel to an outer side of the aircraft partition wall. For example, the movement mechanism is arranged or fastened on the outer side of the aircraft partition wall. It is conceivable that the rest surface of the footrest in the stowage state bears against the outer side of the aircraft partition wall.

It is also conceivable that the footrest forms a part of the aircraft partition wall. For example, the footrest is inserted into the opening in the aircraft partition wall. For example, the footrest is inserted into the opening in the aircraft partition wall in such a way that, in the stowage state, the rest surface of the footrest and/or a rear side of the footrest are flush with the outer side of the aircraft partition wall.

It is also proposed that the footrest has two rest elements which are pivotably connected to one another. As a result, the footrest is designed to be comparatively compact and space-saving in the stowage state.

For example, the footrest is formed in two parts, comprising a first rest element and a second rest element. For example, the two rest elements in an open state together form the rest surface of the footrest. For example, the first of the two rest elements is pivotable, for example rotatable, relative to the second of the two rest elements. It is conceivable that the first rest element is pivotably or rotatably connected to the second rest element, for example by means of a rotary joint, for example by means of a hinge or by means of a pivot arm. For example, the first rest element is rotatably articulated on the second rest element by means of a hinge or by means of two hinges. It is also conceivable that the first rest element is mounted displaceably with respect to the second rest element, for example by means of a rail guide.

It is also proposed that the footrest is pivotably connected to the aircraft partition wall by the movement mechanism. This makes it possible to achieve a comparatively simple and stable movement sequence of the footrest.

The movement mechanism has, for example, a rotary joint by means of which the footrest is movable about an axis of rotation of the rotary joint. However, it is also conceivable that the movement mechanism has a multiple joint, as a result of which the footrest is for example pivotable from the stowage state to the use state.

It is conceivable that the aircraft partition wall has a reinforcing region at which the movement mechanism is connected to the aircraft partition wall. As a result, the stability of the aircraft partition wall is comparatively increased. For example, the movement mechanism, the aircraft partition wall and/or the footrest are/is designed to allow the footrest to be loaded with a weight of about 130 kg to 140 kg in the use position. In particular, the movement mechanism, the aircraft partition wall and/or the footrest are/is designed to allow the footrest to be loaded with a weight of about 130 kg to 140 kg in the use position, without yielding downward, for example springing.

It is also proposed that the movement mechanism is designed such that the footrest in the use position is adjustable in the vertical direction and/or horizontal direction so that the footrest can be used both as a footrest and as a table. As a result, a range of application of the footrest is increased in a comparatively simple manner.

For example, the movement mechanism has a pull-out or a rail guide by means of which the footrest can be moved and/or adjusted in height, in the vertical direction, and/or in the plane, in the horizontal direction. For example, the orientation is always to be seen in the arranged state of the aircraft compartment partition in the aircraft.

It is also proposed that a handle element is present in order to move the footrest from the stowed position to the use position by a force of the passenger. This simplifies the operation of the footrest.

For example, the handle element is designed as a handle, as a bracket or as a handle recess. It is conceivable that the handle element is arranged on a rest element.

In addition, it is proposed that the movement mechanism has a latching element in order to latch the footrest in the use position and/or the stowed position. This ensures that the footrest is secured in the use position and/or the stowed position, so that an escape route is maintained in the event of an evacuation.

For example, the movement mechanism has an unlocking lever which is coupled to the latching element. For example, the latching of the latching element is released and/or locked by an actuation, for example by a movement, of the unlocking lever.

It is also proposed that the movement mechanism and the footrest are designed and arranged on the aircraft partition wall in such a way that the footrest in the stowed position covers the opening in the aircraft partition wall. This improves the esthetics of the aircraft compartment partition.

For example, the footrest is present on the aircraft partition wall in such a way that the rest element or the rest elements in the stowed position covers or cover the opening in the aircraft partition wall. For example, in the use state of the footrest, the opening in the aircraft partition wall together with the rest element or the rest elements form the footrest. As a result, a rest surface of the footrest is increased in a comparatively simple manner.

An aircraft seat ensemble is also proposed, wherein the aircraft seat ensemble comprises an aircraft seat and an aircraft compartment partition according to one of the above-stated design variants, wherein the aircraft seat and the aircraft compartment partition are opposite one another and spaced apart from one another in such a way that the footrest of the aircraft compartment partition forms a rest surface for a foot of the passenger sitting on the aircraft seat. As a result, in the arranged state of the aircraft seat ensemble in the aircraft, a space in an aircraft is advantageously utilized in an improved manner. For example, the aircraft seat ensemble is designed as an aircraft interior ensemble.

For example, the aircraft seat ensemble comprises a seat row comprising two or more aircraft seats which are opposite to and spaced apart from the aircraft compartment partition. For example, the aircraft seat ensemble comprises a seat row having exactly two or having exactly three aircraft seats and exactly one partition wall.

It is further conceivable that a lying surface of the aircraft seat of the aircraft seat ensemble in the reclined state of the aircraft seat is increased by the footrest.

Also proposed is an aircraft having an aircraft compartment partition according to one of the aforementioned embodiment variants or having an aircraft seat ensemble according to one of the aforementioned embodiment possibilities.

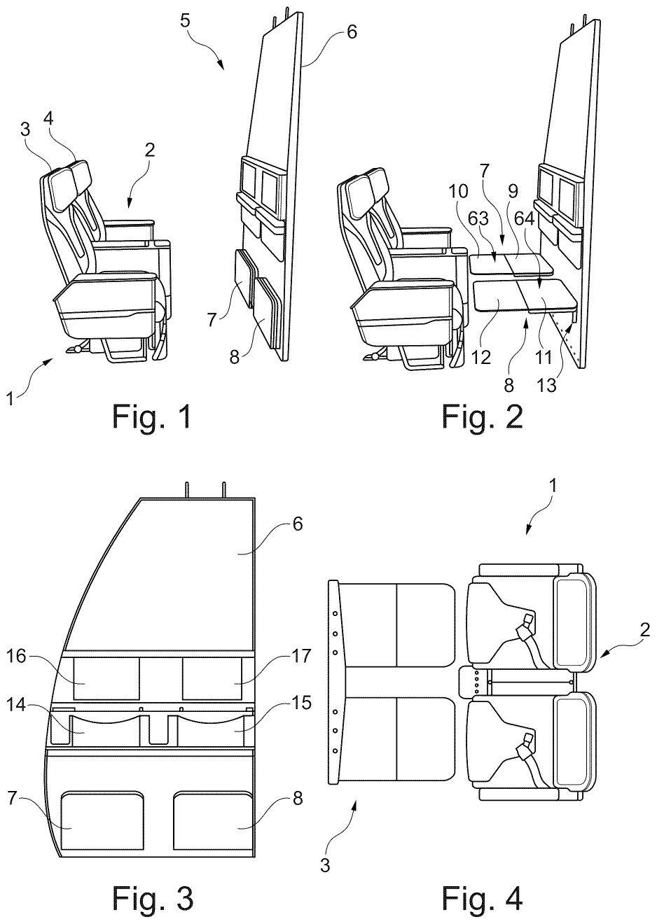

FIG. 1 shows an aircraft seat ensemble 1 comprising an aircraft seat row 2 having two aircraft seats 3, 4 and an aircraft compartment partition 5 in a side view. The aircraft compartment partition 5 has an aircraft partition wall 6 on which a footrest 7, 8 is arranged.

In FIG. 1, the footrest 7, 8 is shown in a folded-up stowage state. FIG. 2 shows the footrest 7, 8 in an unfolded use state.

In FIGS. 1 and 2 it is further shown that the footrest 7, 8 has a first and a second rest element 9 to 12, wherein the first rest element 9, 11 is articulatedly fastened on the aircraft partition wall 6 by means of a movement mechanism 13. The second rest element 10, 12 is movably connected to the first rest element 9, 11. For example, the first and the second rest element 9 to 12 have a rest surface 63, 64. For example, the rest surface 63, 64 forms an outer side of the rest elements 9 to 12.

In FIG. 3, the aircraft partition wall 6 is shown in a view from the front. It is shown that stowage compartments 14, 15 and multimedia technology, such as a screen 16, 17, can be arranged on the aircraft partition wall 6.

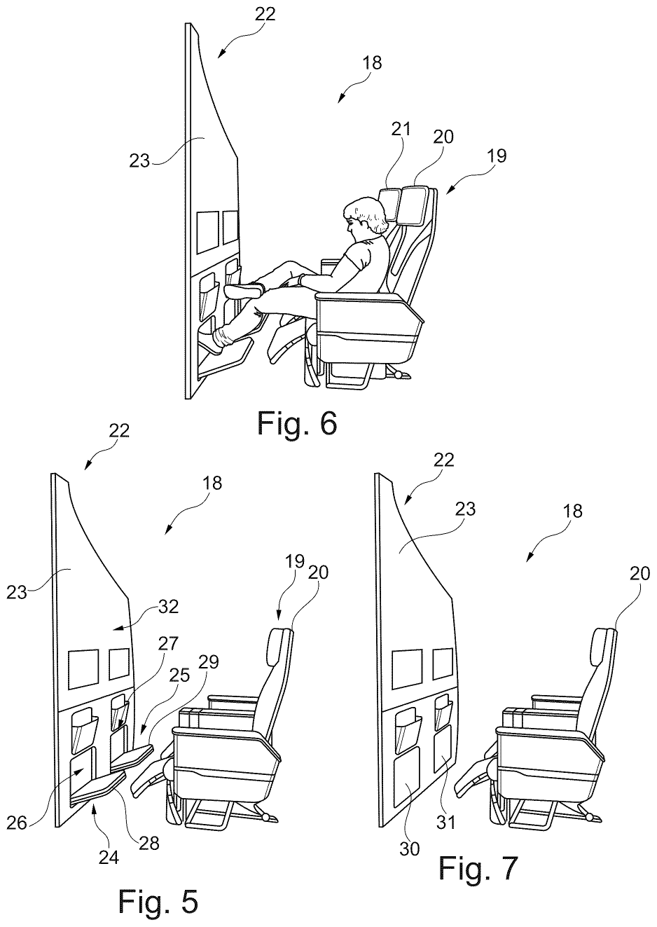

FIGS. 5 to 7 show a further variant of an aircraft seat ensemble 18. The aircraft seat ensemble 18 has an aircraft seat row 19 with two aircraft seats 20, 21 which are arranged opposite an aircraft compartment partition 22. The aircraft compartment partition 22 has an aircraft partition wall 23, wherein footrests 24, 25 are arranged on the aircraft partition wall 23.

The aircraft partition wall 24 has openings 26, 27 in which the footrests 24, 25, for example rest elements 26, 27, can be accommodated so as to be fitted into the openings 28, 29 in the stowage state. For example, in the stowage state, a rear side 30, 31 of the rest elements 26, 27 is flush with an outer side 32 of the aircraft partition wall 24 (FIG. 7).

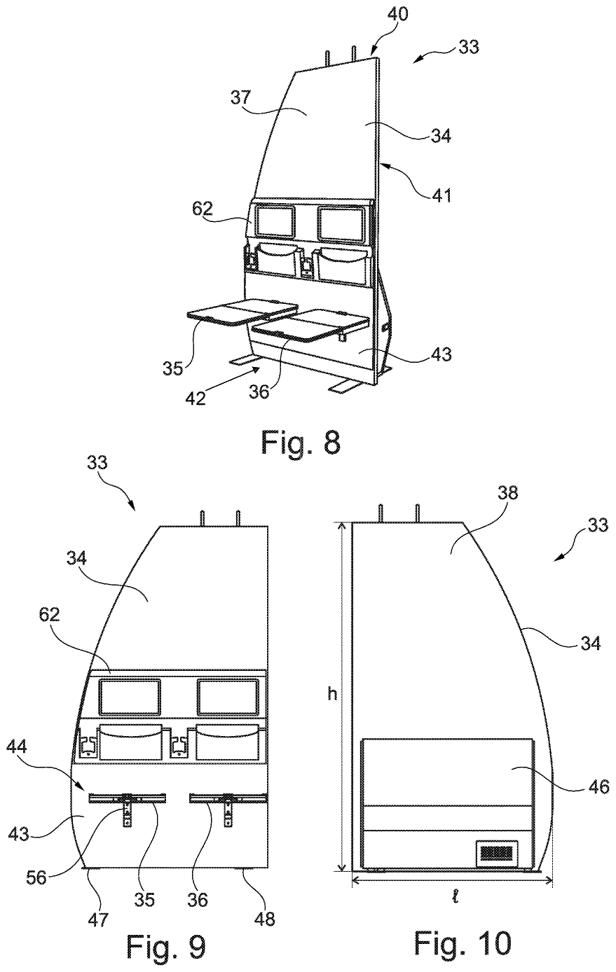

FIGS. 8 to 13 show a further embodiment of an aircraft compartment partition 33, wherein the aircraft compartment partition 33 has an aircraft partition wall 34 and footrests 35, 36 arranged thereon.

The aircraft partition wall 34 extends in a width b, a length l and a height h. The aircraft partition wall 34 has two outer sides 37, 38 and four narrow sides 39 to 42. For example, a narrow side 39 is adapted to an inner contour of an aircraft cabin (not shown) in order, in the arranged state of the aircraft partition wall 34 in the aircraft, to be able to be arranged bearing flush against the inner contour.

The aircraft partition wall 34 has a reinforcing region 43 by means of which the aircraft partition wall 34 is designed to be reinforced and on which the footrests 35, 36 are arranged. The reinforcing region 43 is formed, for example, in a plate-like manner and with an outer side 44 forms an outer side of the aircraft partition wall 43.

A multimedia unit with storage compartments 62 is also arranged on the aircraft partition wall 34.

A housing 46, in which, for example, an air-conditioning or ventilation unit can be accommodated, is arranged on a rear side 45 of the aircraft partition wall 34 on the outer side 38. On a lower side of the aircraft partition wall 34 there can be arranged support feet 47, 48 in order to support the aircraft partition wall 34, in the arranged state in the aircraft, on a floor of an aircraft interior.

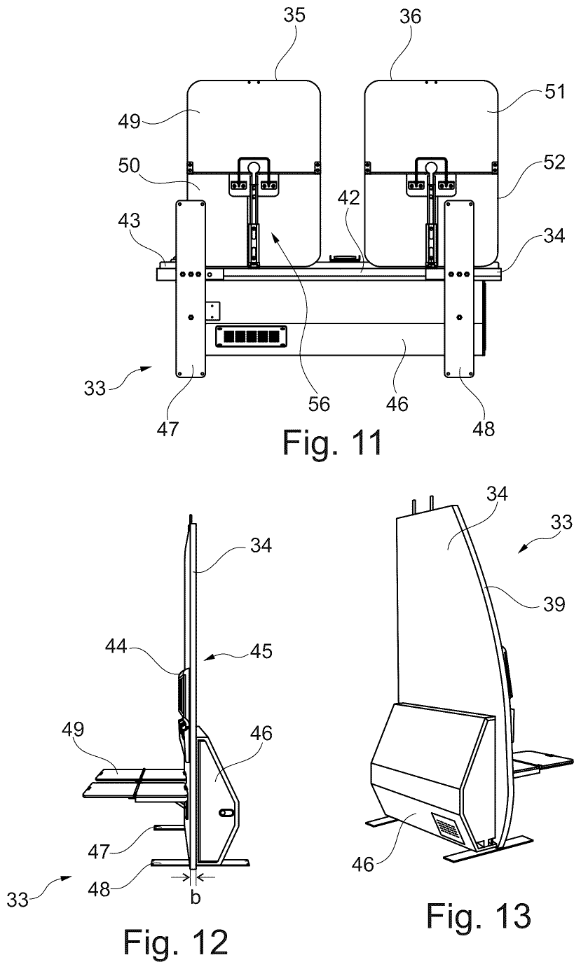

In FIG. 11, the footrests 35, 36 are shown in a use state from below. It is shown that the footrests 35, 36 are composed of a first and a second rest element 49 to 52. The rest elements 49, 50 and 51, 52 are pivotably connected to one another by means of a hinge 53 (FIG. 17). The hinge 53 is able to be releasably connected to the rest elements 49, 50 by means of screws 54, for example.

For example, a handle 55, by means of which the footrest 35 is movable by a user, is arranged on the first rest element 50. At the same time, the handle 55 in the use state can also form a support of the second rest element 49 (FIGS. 11 and 19).

The footrest 35 is movably articulated on the aircraft partition wall 34 by means of a movement mechanism 56. The movement mechanism 56 has, for example, a latching element 57 by means of which the footrest 35 is locked in the use state, for example automatically. It is conceivable that the movement mechanism 56 has an unlocking lever 58 by means of which the latching element 57 can be unlocked. For example, the unlocking lever 58 is articulated on or connected to the latching element 57.

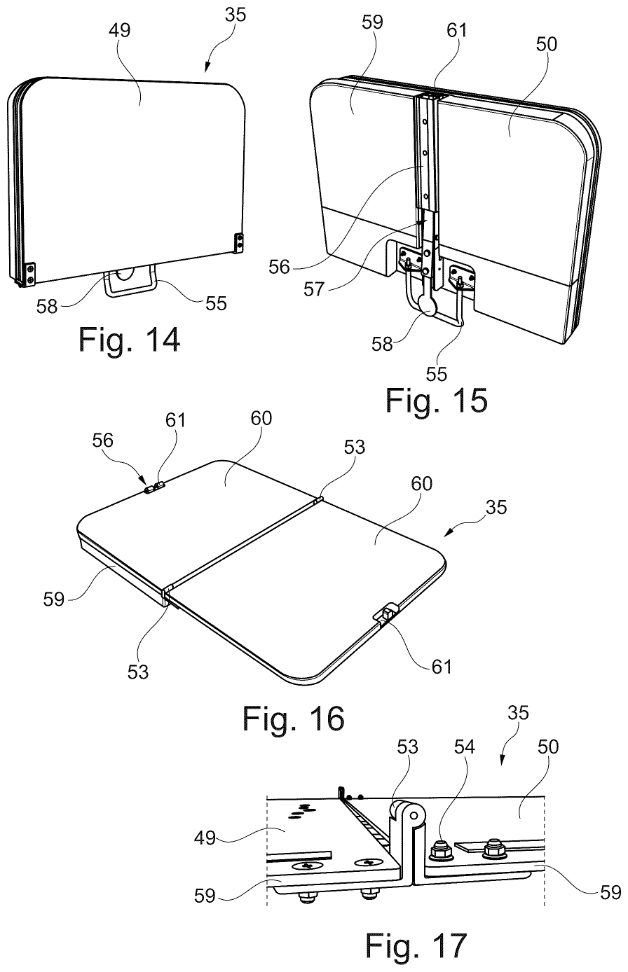

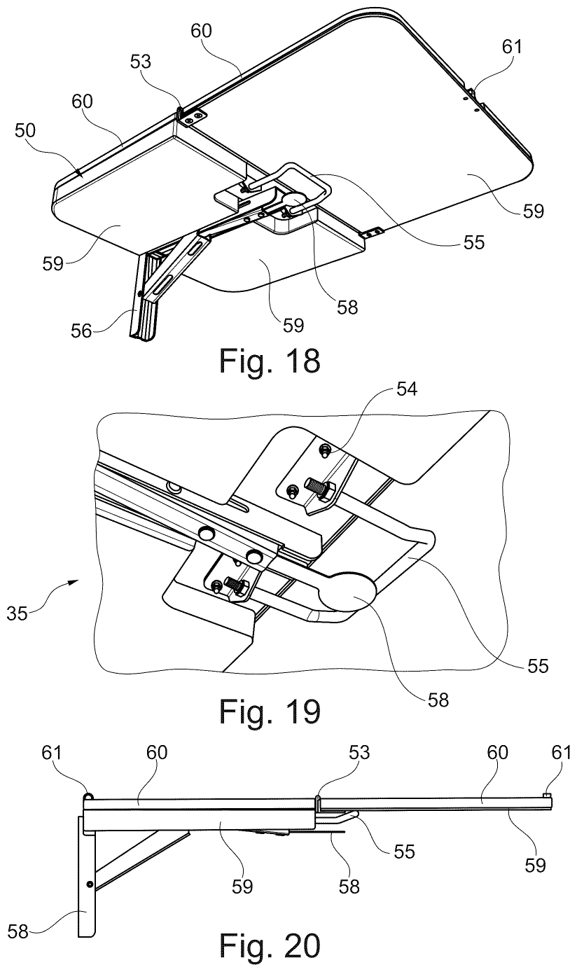

FIGS. 14 to 20 show the footrest 35 with movement mechanism 56 arranged thereon according to the embodiment of FIGS. 8 to 13. A rest element 49, 50 has, for example, a plate-like, stable element 59 on which a second, plate-like element 60 is arranged. The second plate-like element 60 is designed, for example, as a cushion. It is also conceivable that the second, plate-like element 60 has an anti-slip surface, for example an anti-slip coating.

For example, locking elements 61 are present on the two rest elements 49, 50 of the footrest 35, wherein the locking elements 61 latch with one another in the stowage state of the footrest 35 so that the two rest elements 49, 50 are latched with one another in the stowage state.

Although the present invention has been described with reference to preferred embodiments, workers skilled in the art will recognize that changes may be made in form and detail without departing from the spirit and scope of the invention.

### LIST OF REFERENCE SIGNS

1 Aircraft seat ensemble
2 Aircraft seat row
3 Aircraft seat
4 Aircraft seat
5 Aircraft compartment partition
6 Aircraft partition wall
7 Footrest
8 Footrest
9 Rest element
10 Rest element
11 Rest element
12 Rest element
13 Movement mechanism
14 Stowage compartment
15 Stowage compartment
16 Screen
17 Screen
18 Aircraft seat ensemble
19 Aircraft seat row
20 Aircraft seat
21 Aircraft seat
22 Aircraft compartment partition
23 Aircraft partition wall
24 Footrest
25 Footrest
26 Rest element
27 Rest element
28 Opening
29 Opening
30 Rear side
31 Rear side
32 Outer side
33 Aircraft compartment partition
34 Aircraft partition wall
35 Footrest
36 Footrest
37 Outer side
38 Outer side
39 Narrow side
40 Narrow side
41 Narrow side
42 Narrow side
43 Reinforcing region
44 Outer side
45 Locking elements
46 Housing
47 Support foot
48 Support foot
49 Rest element
50 Rest element
51 Rest element
52 Rest element
53 Hinge
54 Screw
55 Handle
56 Movement mechanism
57 Latching element
58 Unlocking lever
59 Element
60 Element
61 Locking element
62 Multimedia unit
63 Rest surface
64 Rest surface

1. An aircraft compartment partition comprising an aircraft partition wall and a footrest arranged on the aircraft partition wall so that, in an arranged state of the aircraft compartment partition in an aircraft, the footrest of the aircraft partition wall forms a rest surface for a foot of an aircraft passenger sitting on an aircraft seat adjacent to the aircraft partition wall, wherein the aircraft partition wall has an opening into which, in the arranged state of the aircraft compartment partition in the aircraft, the foot of the aircraft passenger sitting on the aircraft seat adjacent to the aircraft partition wall can be received.

2. (canceled)

3. The aircraft compartment partition of claim 1, wherein a movement mechanism is arranged on the aircraft partition wall so that, by the movement mechanism, the footrest is movable from a stowed position to a use position and back.

4. The aircraft compartment partition of claim 3, wherein the footrest is pivotably connected to the aircraft partition wall by the movement mechanism.

5. The aircraft compartment partition of claim 1, wherein the footrest has two rest elements which are pivotally connected to one another.

6. The aircraft compartment partition of claim 3, wherein the movement mechanism is designed in such a way that the footrest in the use position is adjustable in a vertical direction and/or a horizontal direction so that the footrest can be used both as the rest surface and as a table.

7. The aircraft compartment partition of claim 1, wherein a handle element is present in order to move the footrest from a stowed position to a use position by a force of the aircraft passenger.

8. The aircraft compartment partition of claim 3, wherein the movement mechanism has a latching element in order to latch the footrest in the use position and/or the stowed position.

9. The aircraft compartment partition of claim 3, wherein the movement mechanism and the footrest are designed and arranged on the aircraft partition wall in such a way that the footrest in the stowed position covers the opening in the aircraft partition wall.

10. An aircraft seat ensemble comprising an aircraft seat and an aircraft compartment partition comprising an aircraft partition wall and a footrest arranged on the aircraft partition wall so that, in an arranged state of the aircraft compartment partition in an aircraft, the footrest of the aircraft partition wall forms a rest surface for a foot of an aircraft passenger sitting on the aircraft seat adjacent to the aircraft partition wall, wherein the aircraft seat and the aircraft compartment partition are opposite one another and spaced apart from one another in such a way that the footrest of the aircraft compartment partition forms the rest surface for the foot of the aircraft passenger sitting on the aircraft seat, and wherein the aircraft partition wall has an opening into which, in the arranged state of the aircraft compartment partition in the aircraft, the foot of the aircraft passenger sitting on the aircraft seat adjacent to the aircraft partition wall can be received.

11. An aircraft comprising:
an aircraft seat; and
an aircraft compartment partition comprising an aircraft partition wall and a footrest arranged on the aircraft partition wall so that, in an arranged state of the aircraft compartment partition in the aircraft, the footrest of the aircraft partition wall forms a rest surface for a foot of an aircraft passenger sitting on the aircraft seat adjacent to the aircraft partition wall, wherein the aircraft partition wall has an opening into which, in the arranged state of the aircraft compartment partition in
the aircraft, the foot of the aircraft passenger sitting on the aircraft seat adjacent to the aircraft partition wall can be received.

12. The aircraft of claim 11, wherein a movement mechanism is arranged on the aircraft partition wall so that, by the movement mechanism, the footrest is movable from a stowed position to a use position and back.

13. The aircraft of claim 12, wherein the footrest is pivotably connected to the aircraft partition wall by the movement mechanism.

14. The aircraft of claim 11, wherein the footrest has two rest elements which are pivotally connected to one another.

15. The aircraft of claim 12, wherein the movement mechanism is designed in such a way that the footrest in the use position is adjustable in a vertical direction and/or a horizontal direction so that the footrest can be used both as the rest surface and as a table.

16. The aircraft of claim 11, wherein a handle element is present in order to move the footrest from a stowed position to a use position by a force of the aircraft passenger.

17. The aircraft seat ensemble of claim 10, wherein a movement mechanism is arranged on the aircraft partition wall so that, by the movement mechanism, the footrest is movable from a stowed position to a use position and back.

18. The aircraft seat ensemble of claim 17, wherein the footrest is pivotably connected to the aircraft partition wall by the movement mechanism.

19. The aircraft seat ensemble of claim 10, wherein the footrest has two rest elements which are pivotally connected to one another.

20. The aircraft seat ensemble of claim 17, wherein the movement mechanism is designed in such a way that the footrest in the use position is adjustable in a vertical direction and/or a horizontal direction so that the footrest can be used both as the rest surface and as a table.

21. The aircraft seat ensemble of claim 10, wherein a handle element is present in order to move the footrest from a stowed position to a use position by a force of the aircraft passenger.
